(19) United States
(12) Patent Application Publication
(10) Pub. No.: US 2026/0063164 A1
(43) Pub. Date: Mar. 5, 2026

(54) FASTENED MEMBER

(71) Applicant: TOYOTA JIDOSHA KABUSHIKI KAISHA, Toyota-shi (JP)

(72) Inventors: Takashi USHIJIMA, Nagoya-shi (JP); Hirotaka SATO, Nagoya-shi (JP)

(21) Appl. No.: 19/232,947

(22) Filed: Jun. 10, 2025

(30) Foreign Application Priority Data
Aug. 27, 2024 (JP) 2024-145451

(51) Int. Cl. F16B 39/284; F16B 5/02

(52) U.S. Cl. CPC F16B 39/284; F16B 5/0291

(57) ABSTRACT

A fastened member configured to be fixed to a vehicle body-side member by a screw member includes: a base including a reference surface configured to receive a bearing surface of the screw member; an insertion hole provided in the base and configured to insert the screw member therethrough, and a protruding portion protruding from the reference surface. The protruding portion includes a tilted surface tilted so as to become higher along a rotation direction in which the screw member is tightened. When the screw member is tightened, the protruding portion and the base are sandwiched between the vehicle body-side member and the bearing surface and are plastically and elastically deformed.

### CROSS-REFERENCE TO RELATED APPLICATION

This application claims priority to Japanese Patent Application No. 2024-145451 filed on Aug. 27, 2024. The disclosure of the above-identified application, including the specification, drawings, and claims, is incorporated by reference herein in its entirety.

### BACKGROUND

### 1. Technical Field

The present disclosure relates to a fastened member that is fastened to a vehicle body-side member by a screw member.

### 2. Description of Related Art

Japanese Unexamined Patent Application Publication No. 2010-253697 (JP 2010-253697 A) discloses that a fiber-reinforced composite material is fastened to a metal material by a bolt. The fiber-reinforced composite material is formed in layers using thermosetting resin and carbon fiber. The fiber-reinforced composite material includes a fastening through hole for inserting a bolt, and an iron coating layer formed on the inner periphery of the fastening through hole. The iron coating layer is formed by applying powder.

### SUMMARY

The fiber-reinforced composite material disclosed in JP 2010-253697 A is expensive because a different material is prepared in addition to a base material and a process of applying the prepared material is performed in order to apply iron to the fastening through hole.

The present disclosure provides a technique that reduces creep deformation of a fastened member fastened by a screw member and that also reduces cost.

An aspect of the present disclosure is a fastened member configured to be fixed to a vehicle body-side member by a screw member.

The fastened member includes:
a base including a reference surface configured to receive a bearing surface of the screw member.
ad insertion hole provided in the base and configured to allow the screw member to be inserted into the insertion hole; and
a protruding portion protruding from the reference surface.
   The protruding portion includes a tilted surface tilted so as to become higher along a rotation direction in which the screw member is tightened.
   When the screw member is tightened, the protruding portion and the base are sandwiched between the vehicle body-side member and the bearing surface and are plastically and elastically deformed.

The present disclosure can provide a technique that reduces creep deformation of a fastened member fastened by a screw member and that also reduces cost.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating a fastened member fixed to a vehicle body-side member by a screw member of an embodiment.

FIG. 2A is a top view mainly showing a base of the fastened member.

FIG. 2B is a sectional view of the base taken along line IIA-IIA in FIG. 2A.

FIG. 3 is a sectional view of the base taken along line IIB-IIB in FIG. 2A.

FIG. 4A is a sectional view of the fastened member after completion of fastening at the position of line IIA-IIA of the base shown in FIG. 2A;

FIG. 4B is a sectional view of the fastened member after completion of fastening at the position of line IIC-IIC of the base shown in FIG. 2A; and

FIG. 5 is a sectional view of a base of a modification.

### DETAILED DESCRIPTION OF EMBODIMENTS

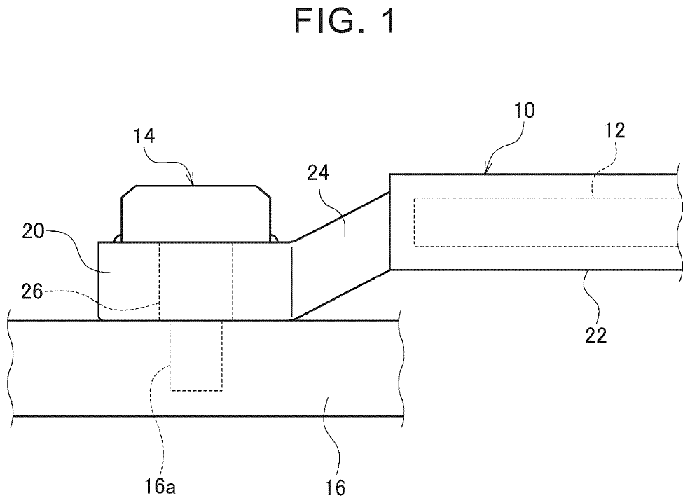

FIG. 1 shows a fastened member 10 fixed to a vehicle body-side member 16 by a screw member 14 of an embodiment. The fastened member 10 includes a base 20, a case 22, and an extending portion 24, and is provided as a single-piece member made of the same resin material.

The case 22 houses and holds the electronic component 12. The electronic component 12 may be an electronic board such as an in-vehicle ECU (electronic control unit). The electronic substrate may be arranged in a vertical direction or in a horizontal direction. The fastened member 10 functions as a component holding member that holds the electronic component 12.

The extending portion 24 is formed in a columnar shape and extends from the case 22. The base 20 is fixed to the vehicle body-side member 16 by the screw member 14. When fastened, the base 20 is sandwiched between the screw member 14 and the vehicle body-side member 16, and is pressed against the vehicle body-side member 16 by the axial force of the screw member 14. The base 20 has an insertion hole 26 into which the screw member 14 can be inserted. A plurality of the bases 20 and a plurality of the extending portions 24 are provided for the case 22.

The vehicle body-side member 16 is, for example, a vehicle body panel, a vehicle body frame, or a metal bracket fixed to the vehicle body frame, and is a member constituting the vehicle body in any case. The vehicle body-side member 16 has a screw hole 16a that constitutes a female screw. The screw member 14 fastens the base 20 to the vehicle body-side member 16. The screw member 14 is, for example, a bolt.

The case 22 is located away from the surface of the vehicle body-side member 16. The shape and length of the extending portion 24 and its angle with respect to the case 22 can be set according to the mounting position of the electronic component 12, and are not limited to the form shown in FIG. 1. In any case, the extending portion 24 extends toward the vehicle body-side member 16 that is a mounting target. The base 20 is coupled to the extending portion 24.

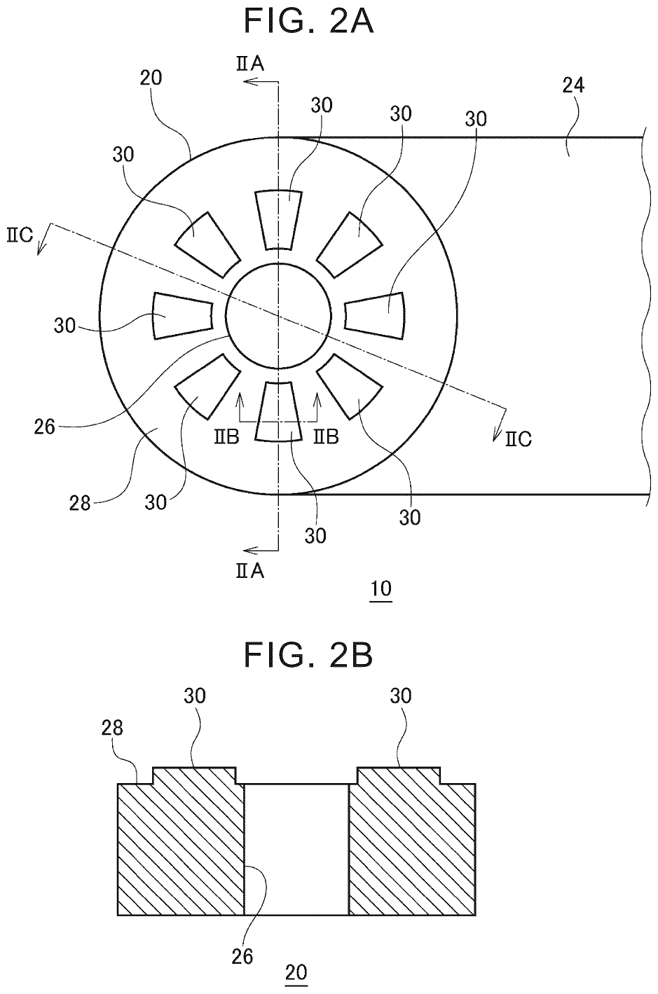

FIG. 2A is a top view mainly showing the base 20 of the fastened member 10, FIG. 2B is a sectional view of the base 20 taken along line IIA-IIA in FIG. 2A. The base 20 has an insertion hole 26, a reference surface 28, and a protruding portion 30.

The insertion hole 26 is formed to penetrate through the center of the base 20, and can insert a threaded portion of the screw member 14. The central axial direction of the insertion hole 26 is simply referred to as an axial direction. The central axis direction of the insertion hole 26 and the axial direction of the screw member 14 in the attached state are substantially the same. The circumferential direction refers to a direction orthogonal to the axial direction and rotating around the axis. The radial direction means a direction orthogonal to the axial direction and extending in the radial direction.

The reference surface 28 is a surface of the base 20 and is flat. The protruding portion 30 protrudes from the reference surface 28. A plurality of protruding portions 30 is formed spaced apart from each other in the circumferential direction. Since the protruding portions 30 are spaced apart from each other, the protruding portions can be more easily crashed than when the protruding portion is formed in an annular shape.

The protruding portion 30 is formed such that its radial width is longer than its circumferential width. The plurality of protruding portions 30 may include a protruding portion 30 formed such that its radial width is longer than its circumferential width. The protruding portion 30 is formed so as to be long in the radial direction. The protruding portions 30 are thus formed so as to extend in a radial pattern, stress is generated on both the inner diameter side and the outer diameter side during fastening, which reduces uneven application of the stress.

The protruding portion 30 is formed in a fan shape that becomes wider in the circumferential direction toward the outer side in the radial direction. The plurality of protruding portions 30 may include a protruding portion 30 formed in a fan shape that becomes wider in the circumferential direction toward the outer side in the radial direction. Since the circumferential width is different between the inner diameter side and the outer diameter side, it can be set so that the stress generated during fastening decreases from the inner diameter side toward the outer diameter side. As a result, creep deformation can be suppressed toward the outer diameter side, the fastening force on the outer diameter side where the contact surface increases can be maintained, and rattling can be suppressed over time.

The plurality of protruding portions 30 is located away from the edge of the insertion hole 26. As a result, part of the plurality of protruding portions 30 is less likely to be crushed radially inward during fastening so as to tilt the screw member 14. The plurality of protruding portions 30 is disposed at positions closer to the inner peripheral edge than the outer peripheral edge of the base 20.

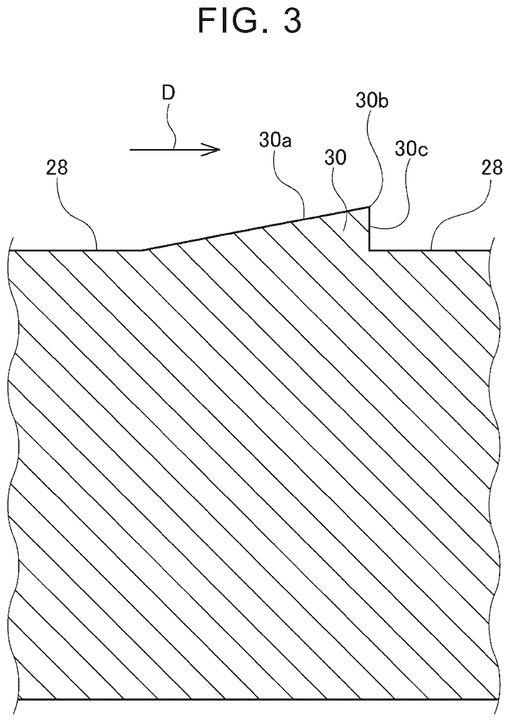

FIG. 3 is a sectional view of the base 20 taken along line IIB-IIB in FIG. 2A. The protruding portion 30 has a tilted surface 30a tilted so as to be higher along the rotation direction D in which the screw member 14 is tightened. The rotation direction D in which the screw member 14 is tightened is counterclockwise in FIG. 3, but the rotation direction D is not limited to this embodiment and may be clockwise. In any case, the rotation direction D is one of the two rotation directions and is along the circumferential direction around the central axis.

The tilted surface 30a extends from the reference surface 28 to the highest protruding end 30b. The protruding portion 30 has a vertical surface 30c extending downward from the protruding end 30b to the reference surface 28. Since the vertical surface 30c stands vertically from the reference surface 28, the protruding end 30b can be easily sharped so as to be easily crushed.

Since the protruding portion 30 is formed so as to become higher along the rotation direction D in which the screw member 14 is tightened, the protruding portion is less likely to be caught by the bearing surface 34 of the screw member 14 while the screw member 14 is being tightened. Moreover, when the tightening of the screw member 14 is completed, the corner of the protruding end 30b is less likely to be caught by the screw member 14 and the screw member 14 is less likely to loosen. The tilted surface 30a may be flat along the tilt, but may be curved.

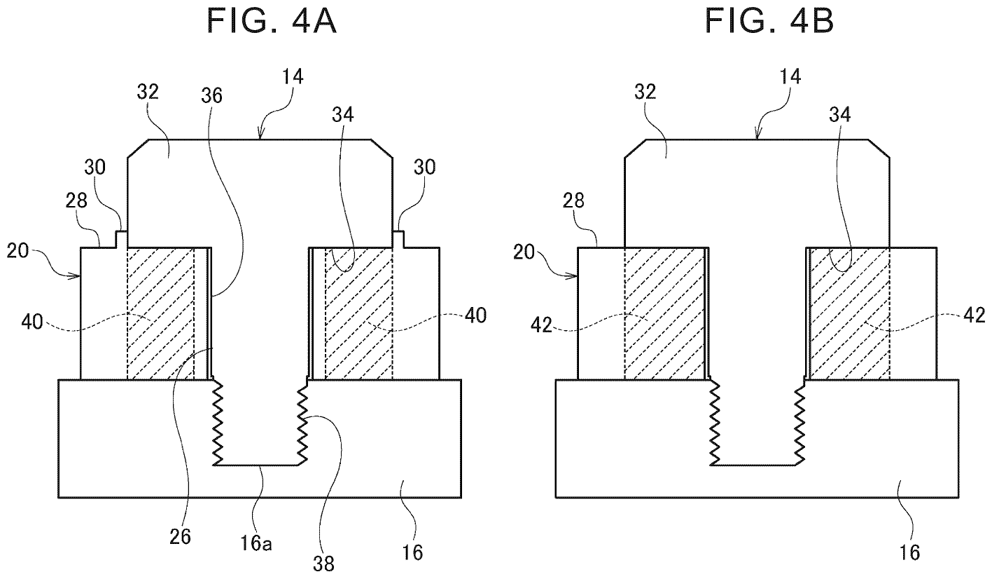

FIGS. 4A and 4B are sectional views of the fastened member 10 after completion of fastening. FIG. 4A shows a cross section of the base 20 at the position of line IIA-IIA in FIG. 2A, and FIG. 4B shows a cross section of the base 20 at the position of line IIC-IIC in FIG. 2A. That is, FIG. 4A shows a cross section of a portion where the protruding portions 30 are provided, and FIG. 4B shows a cross section of a portion where the protruding portions 30 are not provided.

The screw member 14 has a head 32, a bearing surface 34, a cylindrical portion 36, and a threaded portion 38. The bearing surface 34 is located on the rear surface of the head 32. The cylindrical portion 36 is located closer to the head 32 than the threaded portion 38, and hangs down from the rear surface of the head 32. The threaded portion 38 constitutes a male screw. When the head 32 is rotated by the tool, the threaded portion 38 moves forward and backward with respect to the screw hole 16a.

With the base 20 placed on the vehicle body-side member 16, the insertion hole 26 is aligned with the screw hole 16a of the vehicle body-side member 16, and the screw member 14 is inserted into the insertion hole 26. The insertion hole 26 has a larger diameter than the cylindrical portion 36 and the threaded portion 38.

The threaded portion 38 is screwed into the screw hole 16a, and the bearing surface 34 presses the protruding portion 30. The protruding portion 30 is deformed so as to be crushed, and the reference surface 28 receives the bearing surface 34. The screw member 14 is tightened until the protruding portion 30 and its surrounding portion are deformed and reach the reference surface 28.

The protruding portion 30 constitutes a deformation portion that is to be deformed by being pressed by the bearing surface 34 during fastening. The protruding portion 30 may be at least plastically deformed and partially elastically deformed.

As shown in FIG. 4A, part of the protruding portion 30 that protrudes beyond the head 32 remains. The plurality of protruding portions 30 includes a protruding portion 30 formed so as to protrude radially outward beyond the bearing surface 34. That is, the protruding portion 30 is formed at such a position that it extends radially outward beyond the bearing surface 34 and protrudes radially outward beyond the bearing surface 34. This allows the worker to visually check the degree to which the protruding portion 30 is crushed and to easily check the degree to which the screw member 14 is tightened.

As shown in FIG. 4A, the protruding portion 30 and part of the base 20 located on the back side of the protruding portion 30 are pressed by the bearing surface 34 and are deformed together to form the first deformation region 40. The first deformation region 40 is a portion pressed by the bearing surface 34 and is a region of the base 20 that axially overlaps the protruding portion 30 with the protruding portion 30.

As shown in FIG. 4B, the base 20 without the protruding portion 30 is pressed against the reference surface 28 by the bearing surface 34 to form the second deformation region 42. The second deformation region 42 is a region of the base 20 that overlaps with the bearing surface 34 but does not overlap with the protruding portion 30.

Since the first deformation region 40 is longer in the axial direction by the height of the protruding portion 30 than the second deformation region 42, the stress is increased. Therefore, the first deformation region 40 is plastically and elastically deformed. The first deformation region 40 is not only plastically deformed by the protruding portion 30, but the entire first deformation region 40 is compressed, and the boundary between the plastic deformation and the elastic deformation may be difficult to distinguish, but is also plastically deformed by a larger volume ratio in the second deformation region 42. The second deformation region 42 is elastically deformed and may be plastically deformed by the axial force of the screw member 14.

Since the plurality of protruding portions 30 is spaced apart from each other in the circumferential direction, the first deformation region 40 in which the stress increases and the second deformation region 42 in which the stress decreases are located separately in the circumferential direction. The stress applied to the first deformation region 40 can be released to the second deformation region 42, and the occurrence of creep in the first deformation region 40 can be suppressed.

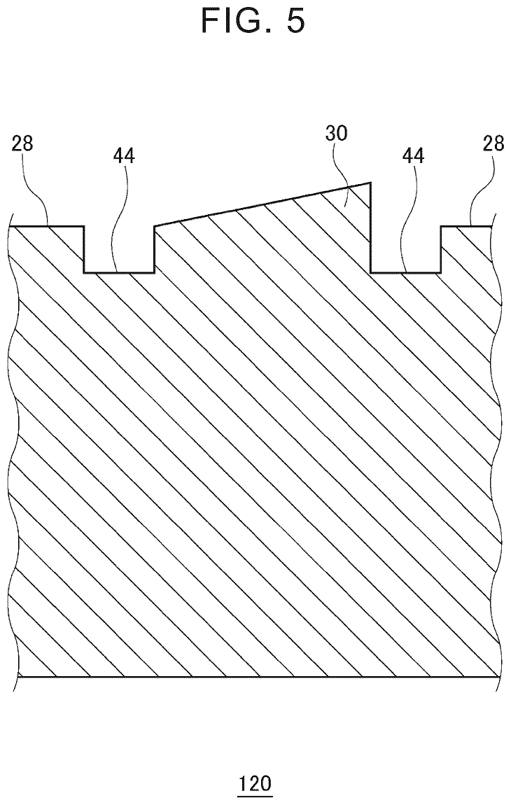

FIG. 5 is a sectional view of a base 120 of a modification. The base 120 of the modification has a different surface shape than the base 20 shown in FIG. 3. The base 120 includes a recessed portion 44 recessed from the reference surface 28 and adjacent to the protruding portion 30.

The recessed portion 44 is located on both sides in the circumferential direction of the protruding portion 30. The recessed portion 44 may not be located radially inward and radially outward of the protruding portion 30. That is, the recessed portion 44 may be located only on both sides in the circumferential direction of the protruding portion 30. As a result, when the protruding portion 30 is crushed, the recessed portion 44 becomes a clearance space, and the protruding portion 30 can be easily crushed.

The recessed portion 44 is formed to be smaller than the circumferential width of the protruding portion 30. The recessed portion 44 is formed with a recessed amount equal to or smaller than the protruding height of the protruding portion 30 from the reference surface 28. The volume of the recessed portion 44 is smaller than the volume of the protruding portion 30.

The recessed portion 44 may be formed only on one side of the protruding portion 30, and may be formed only along the vertical surface 30c. That is, the recessed portion 44 may be formed only on the protruding end 30b. In any case, the recessed portion 44 is formed along the protruding portion 30.

The plurality of protruding portions 30 may have a uniform circumferential width in the radial direction. That is, the protruding portion 30 may be formed in a rectangular shape in a top view. As a result, the circumferential width of the protruding portion 30 is constant, and creep deformation is uniformly formed along the radial direction. Since the circumferential distance of the plurality of protruding portions 30 is formed so as to expand radially outward, it is possible to suppress creep deformation radially outward.

The plurality of protruding portions 30 may not only be spaced apart from each other in the radial direction, but may also be spaced apart from each other in the radial direction. The present disclosure is not limited to the form in which the plurality of protruding portions 30 is spaced apart from each other at equal intervals in the circumferential direction, and the plurality of protruding portions may be spaced apart from each other at different intervals in the circumferential direction The plurality of protruding portions 30 may be circular or elliptical as viewed from above. The plurality of protruding portions 30 may be a combination of these shapes.

The present disclosure has been described above based on examples. The present disclosure is not limited to the above-described embodiments, and various modifications such as design changes can be made based on knowledge of a person skilled in the art.

For example, the fastened member 10 may be a single-piece member including the base 20 and the extending portion 24, and may be connected to a different member such as the case 22.

What is claimed is:

1. A fastened member configured to be fixed to a vehicle body-side member by a screw member, the fastened member comprising:
a base including a reference surface configured to receive a bearing surface of the screw member;
an insertion hole provided in the base and configured to allow the screw member to be inserted into the insertion hole; and
a protruding portion protruding from the reference surface, wherein:
the protruding portion includes a tilted surface tilted so as to become higher along a rotation direction in which the screw member is tightened; and
when the screw member is tightened, the protruding portion and the base are sandwiched between the vehicle body-side member and the bearing surface and are plastically and elastically deformed.

2. The fastened member according to claim 1, wherein a plurality of the protruding portions is provided spaced apart from each other in a circumferential direction.

3. The fastened member according to claim 1, wherein the protruding portion is provided so as to protrude radially outward beyond the bearing surface.

4. The fastened member according to claim 1, wherein the base includes a recessed portion recessed from the reference surface and adjacent to the protruding portion.

5. The fastened member according to claim 1, further comprising:
a case configured to support an electronic component; and
an extending portion extending from the case and connected to the base,
wherein the base, the case, and the extending portion are provided as a single-piece member made of a resin material.
